(19) United States
(12) Patent Application Publication
(10) Pub. No.: US 2014/0150737 A1
(43) Pub. Date: Jun. 5, 2014

(54) Hydronic Catalyst Device for Internal Combustion Engines

(71) Applicant: Terry Joe McMurray, Fort Worth, TX (US)

(72) Inventor: Terry Joe McMurray, Fort Worth, TX (US)

(21) Appl. No.: 13/693,752

(22) Filed: Dec. 4, 2012

(51) Int. Cl. C25B 1/04; F02B 43/10; F02B 43/04

(52) U.S. Cl. CPC C25B 1/04; F02B 43/04; F02B 43/10
USPC 123/3; 204/278

(57) ABSTRACT

A hydronic catalyst device produces hydrogen as a positive catalyst for an internal combustion engine. The hydronic catalyst device employs an electrolysis unit and a current source. The electrolysis unit includes a water container includes a hydrogen/oxygen separator for defining an oxygen chamber and a hydrogen chamber within the water container, a hydrogen outlet for connecting the hydrogen chamber to the internal combustion engine and an oxygen vent for venting the oxygen chamber to atmosphere. The electrolysis unit further includes a water electrolysis conductor within the water container to electrolysis any water in response to a flow of current through the water electrolysis conductor. The current source is electrically connected to the water electrolysis conductor to control a flow of current through the water electrolysis conductor to electrolyze any water within the water container whereby an electrolysis of the water produces a flow of hydrogen as the positive catalyst through the hydrogen outlet to the internal combustion engine and a flow of oxygen through the oxygen vent to atmosphere.

The present invention generally relates to an efficient operation of an internal combustion engine of any type. The present invention specifically relates to the use of hydrogen as a positive catalyst for internal combustion engines.

### BACKGROUND OF THE INVENTION

An internal combustion engine as known in the art is operated on a principle of a combustion of a fuel-air mixture within a space compressed by a piston within a closed cylinder whereby the combustion applies a direct force to the piston to translate the piston within the chamber. To increase the efficiency of internal combustion engine, hydrogen may be added to the fuel to improve the fuel economy and power output of the engine. For example, U.S. Patent Application Publication 2012/0227684A1 to Tain et. al (the “Tain Publication”) describes a process involving an electronic power device to electrolyze water within a container to produce hydrogen and oxygen as fuel directed into the internal combustion engine. While the Tain Publication asserts hydrogen as a fuel enhancement for increasing the efficiency of the internal combustion engine, such electrolysis-based systems often fail efficiency tests.

### BRIEF SUMMARY OF THE INVENTION

The present invention provides an electrolysis-based system that utilizes hydrogen as a positive catalyst for a traditional combustion of a fuel-air mixture within a cylinder of an internal combustion engine.

A first form of the present invention is an electrolysis unit for producing hydrogen as a positive catalyst for an internal combustion engine. The electrolysis unit includes a water container includes a hydrogen/oxygen separator for defining an oxygen chamber and a hydrogen chamber within the water container, a hydrogen outlet for connecting the hydrogen chamber to the internal combustion engine and an oxygen vent for venting the oxygen chamber to atmosphere. The electrolysis unit further includes a water electrolysis conductor within the water container to electrolysis any water in response to a flow of current through the water electrolysis conductor.

A second form of the present invention is a hydronic catalyst device for producing hydrogen as a positive catalyst for an internal combustion engine. The hydronic catalyst device employs an electrolysis unit and a current source. The electrolysis unit includes a water container includes a hydrogen/oxygen separator for defining an oxygen chamber and a hydrogen chamber within the water container, a hydrogen outlet for connecting the hydrogen chamber to the internal combustion engine and an oxygen vent for venting the oxygen chamber to atmosphere. The electrolysis unit further includes a water electrolysis conductor within the water container to electrolysis any water in response to a flow of current through the water electrolysis conductor. The current source is electrically connected to the water electrolysis conductor to control a flow of current through the water electrolysis conductor to electrolyze any water within the water container whereby an electrolysis of the water produces a flow of hydrogen as the positive catalyst through the hydrogen outlet to the internal combustion engine and a flow of oxygen through the oxygen vent to atmosphere.

A third form of the present invention system employing an internal combustion engine and the aforementioned hydronic catalyst device for producing hydrogen as a positive catalyst for the internal combustion engine.

The foregoing forms and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates an exemplary embodiment of a hydronic catalyst device in accordance with the present invention.

FIG. 2 illustrates an open view of a first exemplary embodiment of an electrolysis unit in accordance with the present invention.

FIG. 3 illustrates an exemplary embodiment of a current source in accordance with the present invention.

FIG. 4 illustrates an open view of a second exemplary embodiment of an electrolysis unit in accordance with the present invention.

FIG. 5 illustrates a side view of the second exemplary embodiment of an electrolysis unit in accordance with the present invention.

FIG. 6 illustrates a top view of the second exemplary embodiment of an electrolysis unit in accordance with the present invention.

### DETAILED DESCRIPTON OF THE INVENTION

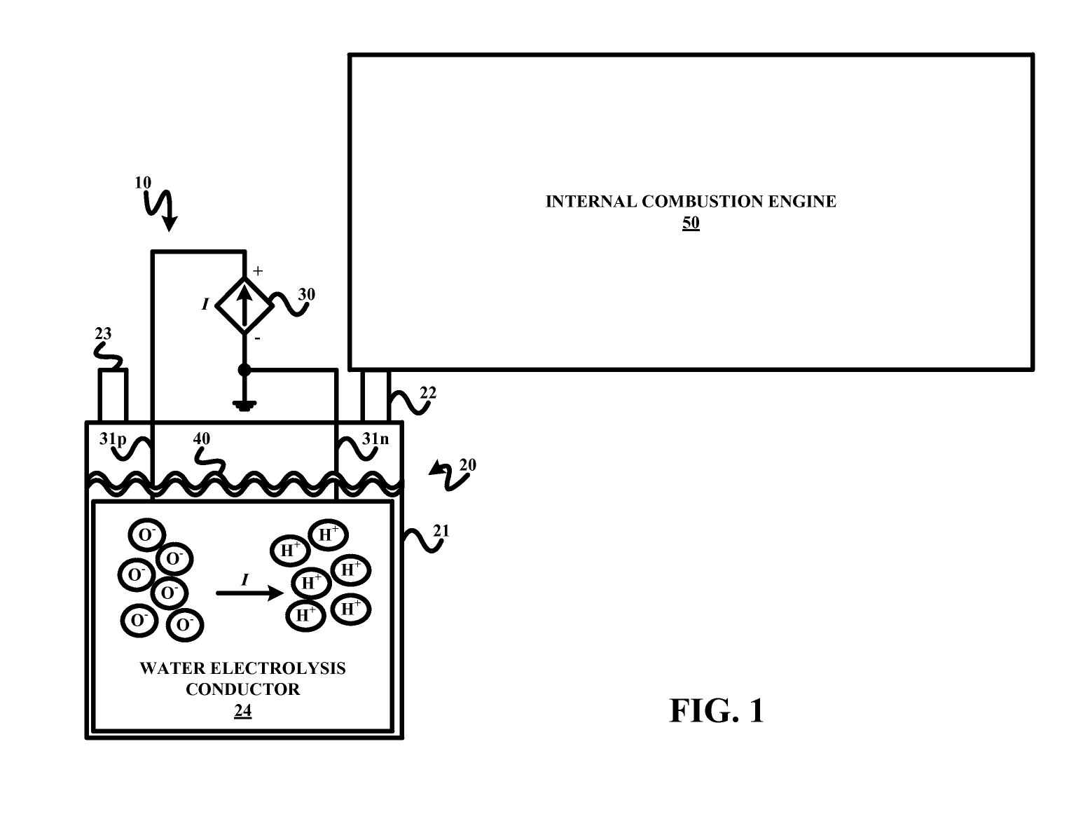

FIG. 1 illustrates a new and unique hydronic catalyst device 10 for producing positive hydrogen ion bubbles H⁺ as a positive catalyst for an internal combustion engine 50 of any type. Hydronic catalyst device 10 employs an electrolysis unit 20 and a current source 30. Electrolysis unit 20 includes a water container 21 having a hydrogen outlet 22 connectable to internal combustion engine 50 and an oxygen vent 23 to atmosphere. Electrolysis unit 20 further includes a water electrolysis conductor 24 within water container 21. Current source 30 is electrically connected to water electrolysis conductor 24 via a positive lead 31p and a negative lead 31n to direct a flow of current I through water electrolysis conductor 24 to electrolyze water 30 within water container 21. An electrolysis of water 30 produces a flow of positive hydrogen ion bubbles H⁺ through hydrogen outlet 22 via negative lead 31n to internal combustion engine 50 and a flow of negative oxygen ion bubbles O⁻ via positive lead 31p through oxygen vent 23 to atmosphere.

For purposes of the present invention, water electrolysis conductor 24 is broadly defined herein as any article or articles structurally composed of any material or materials for conducting current I through water 30 to thereby electrolyze water 30 as known in the art. Thus, in practice, the present invention does not limit any material composition of water electrolysis conductor 24. Also in practice, hydrogen outlet 22 may be connected to an air inlet system of internal combustion engine 50. In one embodiment, hydrogen outlet 22 is connected to an air inlet system of internal combustion engine 50 downstream from a mass air flow sensor (not shown) as known in the art.

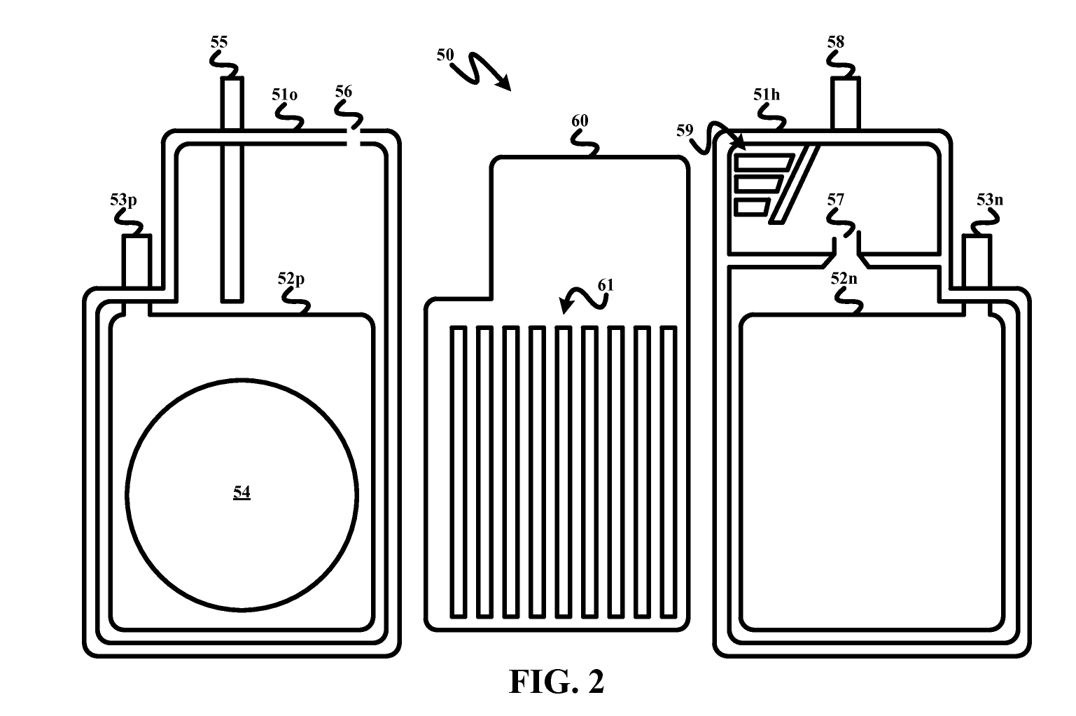

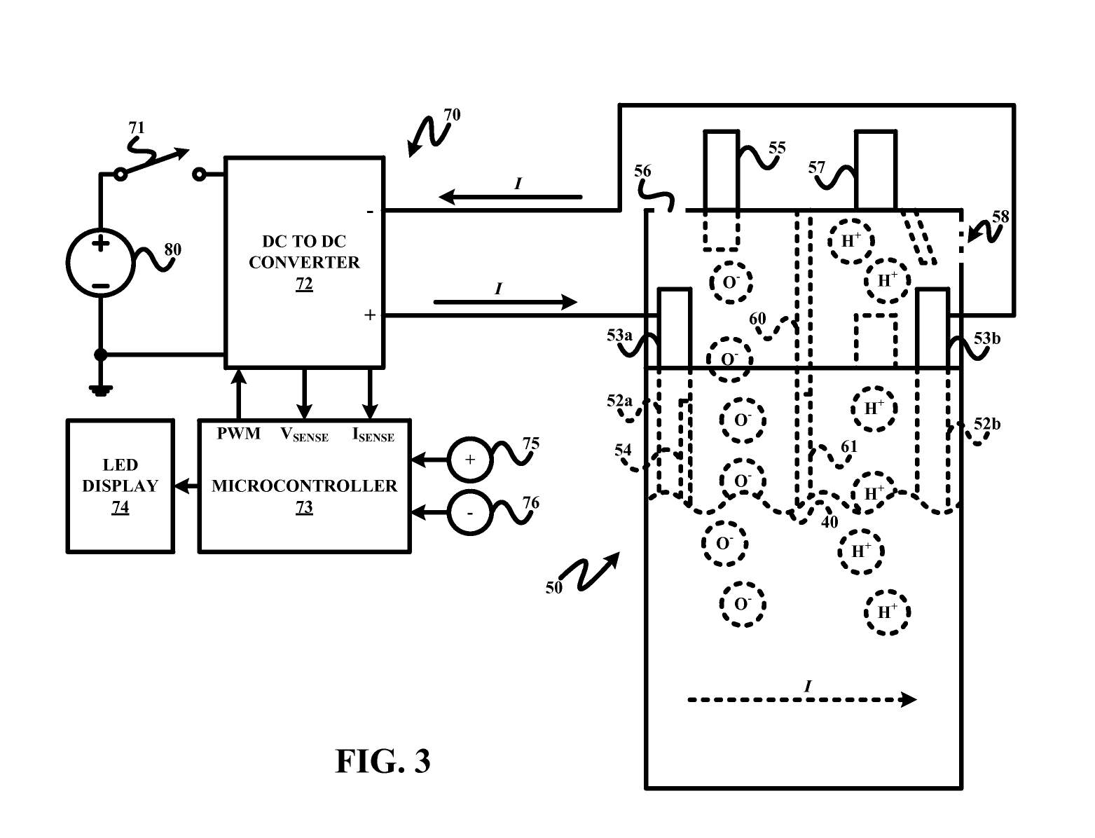

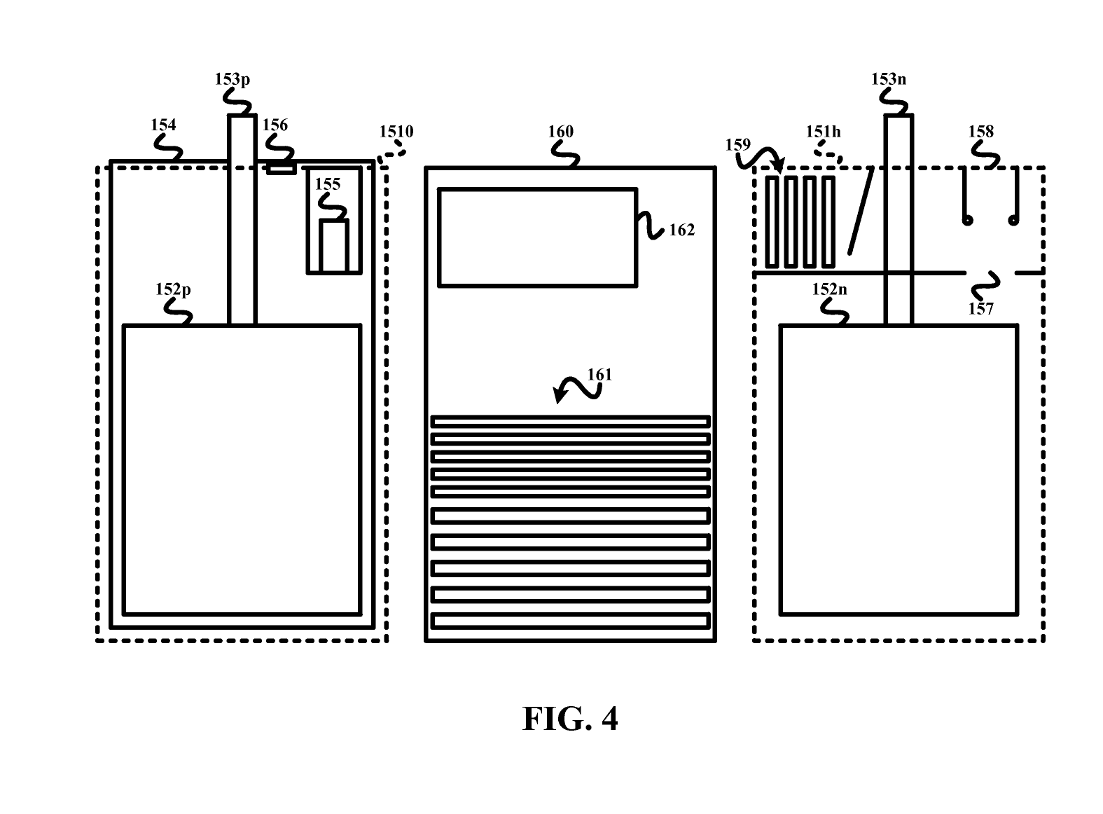

To facilitate a further understanding of the present invention, FIG. 2 illustrates an embodiment 50 of electrolysis unit 20, FIG. 3 illustrates an embodiment 70 of current source 30 and FIGS. 4-6 illustrate an embodiment 150 of electrolysis unit 20.

Referring to FIG. 2, electrolysis unit 50 is disassembled to illustrate an internal view of an oxygen chamber 51o and a hydrogen chamber 51h, both materially composed of high temperature plastic. Oxygen chamber 51o includes a titanium plate 52p having a positive lead 53p for connection to a positive terminal of a current source and a resin infused carbon graphite 54 attached to titanium plate 52p. Oxygen chamber 51o further includes a water inlet 55 for refilling water into electrolysis unit 50 as needed and an oxygen vent 56 for venting oxygen to atmosphere.

Hydrogen chamber 51h also includes a titanium plate 52h having a negative lead 53n for connection to a negative terminal of a current source. Hydrogen chamber 51h further includes a hydrogen channel 57 defining an upper hydrogen chamber, hydrogen outlet 58 for supplying hydrogen as a positive catalyst to an internal combustion engine, and fresh air vents 59 for facilitating a flow of fresh air into the upper hydrogen chamber.

As assembled, oxygen chamber 51o and hydrogen chamber 51h are electrostatically welded with an internal hydrogen-oxygen separator 60 having burn control slots 61 to maintain an integrity of a separation of the chambers yet facilitate the flow of current from titanium plate 52p through water within electrolysis unit 50 to titanium plate 52n. As the water is electrolyzed by a current flow I as shown in FIG. 3, negative oxygen ion bubbles O⁻ will be vented to atmosphere 56 via oxygen vent 56 and positive hydrogen ion bubbles H⁺ will be passively pulled through hydrogen channel 57 and hydrogen outlet 58 to the internal combustion engine via fresh air flowing through air vents 58 responsive to a vacuum of the air intake system of the internal combustion engine.

Still referring to FIG. 3, controlled current source 70 is connected to a front view of an assembled electrolysis unit 50. Specifically, controlled current source 70 employs a DC to DC converter 72 electrically connected to a voltage source 80 (e.g., 12V battery). Converter 72 controls a flow of a constant current I through electrolysis unit 50 responsive to a pulse width modulated signal PWM from a microcontroller 73. The PWM signal is modulated as a function of a voltage sensing signal V_{SENSE} and a current sensing signal I_{SENSE} applied to microcontroller 73 by converter 72. An amplitude of constant current I is provided by a LED display 74 and may be increased or decreased via buttons 75 and 76, respectively.

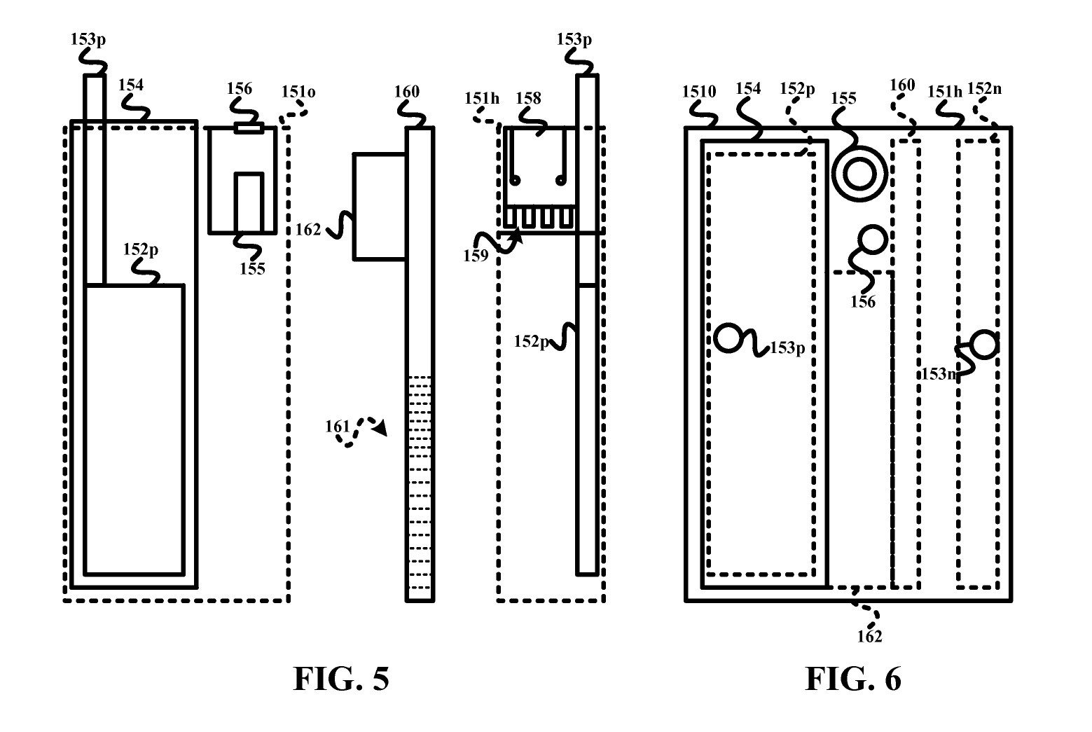

Referring to FIGS. 4 and 5, electrolysis unit 150 is disassembled to illustrate an internal view of an oxygen chamber 151o and a hydrogen chamber 151h, both materially composed of high temperature plastic. Oxygen chamber 151o includes a resin infused carbon graphite titanium plate 152p having a positive lead 153p for connection to a positive terminal of a current source. Oxygen chamber 151o further includes a water inlet 155 for refilling water into electrolysis unit 150 as needed and an oxygen vent 156 for venting oxygen to atmosphere.

Hydrogen chamber 151h also includes a titanium plate 152h having a negative lead 153n for connection to a negative terminal of a current source. Hydrogen chamber 151h further includes a hydrogen channel 157 defining an upper hydrogen chamber, hydrogen outlet 158 for supplying hydrogen as a positive catalyst to an internal combustion engine, and fresh air vents 159 for facilitating a flow of fresh air into the upper hydrogen chamber.

As assembled as best shown in FIG. 6, oxygen chamber 151o and hydrogen chamber 151h are electrostatically welded with an internal hydrogen-oxygen separator 160 having burn control slots 161 to maintain an integrity of a separation of the chambers yet facilitate the flow of current from titanium plate 152p through water within electrolysis unit 150 to titanium plate 152n. As the water is electrolyzed by a current flow, negative oxygen ion bubbles O⁻ (not shown) will be vented to atmosphere 156 via oxygen vent 156 and positive hydrogen ion bubbles H⁺ (not shown) will be passively pulled through hydrogen channel 157 and hydrogen outlet 158 to the internal combustion engine via fresh air flowing through air vents 158 responsive to a vacuum of the air intake system of the internal combustion engine.

Although the present invention has been described with reference to exemplary aspects, features and implementations, the disclosed methods and systems are not limited to such exemplary aspects, features and/or implementations. Rather, as will be readily apparent to persons skilled in the art from the description provided herein, the disclosed systems and methods are susceptible to modifications, alterations and enhancements without departing from the spirit or scope of the present invention. Accordingly, the present invention expressly encompasses such modification, alterations and enhancements within the scope hereof.

1. An electrolysis unit for producing hydrogen as a positive catalyst for an internal combustion engine, the electrolysis unit comprising:
a water container including
a hydrogen/oxygen separator for defining an oxygen chamber and a hydrogen chamber within the water container,
a hydrogen outlet for connecting the hydrogen chamber to the internal combustion engine, and
an oxygen vent for venting the oxygen chamber to atmosphere; and
a water electrolysis conductor within the water container, the water electrolysis conductor operably configured to electrolysis any water within the water container in response to a flow of current through the water electrolysis conductor,
wherein an electrolysis of the water produces a flow of hydrogen as the positive catalyst through the hydrogen outlet to the internal combustion engine and a flow of oxygen through the oxygen vent to atmosphere.

2. A hydronic catalyst device for producing hydrogen as a positive catalyst for an internal combustion engine, the hydronic catalyst device comprising:
a water container including
a hydrogen/oxygen separator for defining an oxygen chamber and a hydrogen chamber within the water container,
a hydrogen outlet for connecting the hydrogen chamber to the internal combustion engine, and
an oxygen vent for venting the oxygen chamber to atmosphere;
a water electrolysis conductor within the water container, the water electrolysis conductor operably configured to electrolysis any water in response to a flow of current through the water electrolysis conductor; and
a current source electrically connected to the water electrolysis conductor, the current source operably configured to control a flow of current through the water electrolysis conductor to electrolyze any water within the water container,
wherein an electrolysis of the water produces a flow of hydrogen as the positive catalyst through the hydrogen outlet to the internal combustion engine and a flow of oxygen through the oxygen vent to atmosphere.

3. A system, comprising:
an internal combustion engine; and
a hydronic catalyst device for producing hydrogen as a positive catalyst for the internal combustion engine, the hydronic catalyst device including:
a water container including
a hydrogen/oxygen separator for defining an oxygen chamber and a hydrogen chamber within the water container,
a hydrogen outlet for connecting the hydrogen chamber to the internal combustion engine, and
an oxygen vent for venting the oxygen chamber to atmosphere;
a water electrolysis conductor within the water container, the water electrolysis conductor operably configured to electrolysis any water in response to a flow of current through the water electrolysis conductor; and
a current source electrically connected to the water electrolysis conductor, the current source operably configured to control a flow of current through the water electrolysis conductor to electrolyze any water within the water container,
wherein an electrolysis of the water produces a flow of hydrogen as the positive catalyst through the hydrogen outlet to the internal combustion engine and a flow of oxygen through the oxygen vent to atmosphere.
